(19) United States
(12) Patent Application Publication
(10) Pub. No.: US 2006/0049605 A1
(43) Pub. Date: Mar. 9, 2006

(54) McPherson front corner module assembly with banana or s-shaped spring

(75) Inventor: Kris Schuyten, Sint-Truiden (BE)

Correspondence Address: HARNESS, DICKEY & PIERCE, P.L.C., P.O. BOX 828, BLOOMFIELD HILLS, MI, 48303, US

(73) Assignee: Tenneco Automotive Operating, Inc., Lake Forest, IL (US)

(21) Appl. No.: 11/222,405

(22) Filed: Sep. 8, 2005

Related U.S. Application Data
(60) Provisional application No. 60/608,554, filed on Sep. 9, 2004.

(51) Int. Cl. B60G 15/07

(52) U.S. Cl. 280/124.146

(57) ABSTRACT

A strut assembly includes a strut having an upper and lower spring seat attached to it. A spring is disposed between the upper and lower spring seat. In its uncompressed state, the spring seat has a non-linear shape such that when it is compressed it exerts a lateral force on the strut. The non-linear shape of the spring in its uncompressed state is designed to allow the insertion of the strut through the spring when the spring is in its uncompressed state.

### FIELD OF THE INVENTION

The present invention relates to a McPherson strut assembly for a motor vehicle. More particularly, the present invention relates to a spring for the McPherson strut assembly which is shaped to compensate for the side load on the McPherson strut assembly while still allowing automated building of the McPherson strut assembly.

### BACKGROUND OF THE INVENTION

Strut-type suspension systems are well known in the motor vehicle industry. A telescopic strut normally incorporating a hydraulic damper is used as one of the locating members for the wheel of the motor vehicle. The most common form of a strut-type suspension system is the McPherson strut suspension system. The McPherson strut assembly includes a coil spring located concentrically around the telescopic strut which is the shock absorber. The upper end of the McPherson strut assembly includes an upper mounting assembly which is mounted in a tower formed by the vehicle body at a position above the wheel arch of the vehicle.

The coil spring is designed to cushion vibrations experienced by the wheel and the strut or shock absorber provides a damping force which dampens the forces experienced by the spring. The positioning of the axis of the strut relative to the vehicle and to the wheel causes a lateral force on the McPherson strut assembly which is generally perpendicular to the axis of the strut assembly. This lateral force is created by the forces exerted on the McPherson strut assembly from the road and from the wheel of the vehicle. This lateral force creates friction at the sealing interface and the rod and cylinder of the strut assembly as well as friction and lateral loading on the top and bottom mounting assemblies for the strut assembly. This frictional load and lateral loading reduces the performance of the shock absorber assembly as well as creating undesirable wear and deterioration of the components of the McPherson strut assembly.

One method for compensating for the lateral loading on the McPherson strut is to shape the spring in such a manner that some or all of the lateral forces are offset. One problem associated with this shaped spring is the effect they have on the automated assembly of the McPherson strut assembly. Because the coil spring is located concentrically around the telescopic strut or shock absorber, for simplification of assembly, it is necessary for the two open ends of the coil spring to be positioned in the free state such that the telescopic strut or shock absorber can be inserted or assembled within both of the two ends of the coil spring.

### SUMMARY OF THE INVENTION

The present invention provides the art with a banana shaped or an S-shaped coil spring for a McPherson strut assembly. The upper and lower end of the coil spring windings are not parallel with each other. The ends can be formed such that a cylindrical space is maintained which extends through both the upper and lower end of the coil spring windings. In this manner, the telescopic strut or shock absorber can be inserted or assembled through the cylindrical space during the assembly process for the McPherson strut assembly.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an illustration of an automobile using the McPherson strut assembly in accordance with the present invention;

FIG. 2 is a side view of one of the front suspension units that incorporate the McPherson strut assembly in accordance with the present invention;

FIG. 3 is a side view of the coil spring shown in FIG. 2 in an uncompressed state; and

FIG. 4 is a side view of a coil spring in accordance with another embodiment of the present invention shown in an uncompressed state.

### DETAILED DESCRIPTION OF THE PREFERRED EMBODIMENTS

The following description of the preferred embodiment(s) is merely exemplary in nature and is in no way intended to limit the invention, its application, or uses.

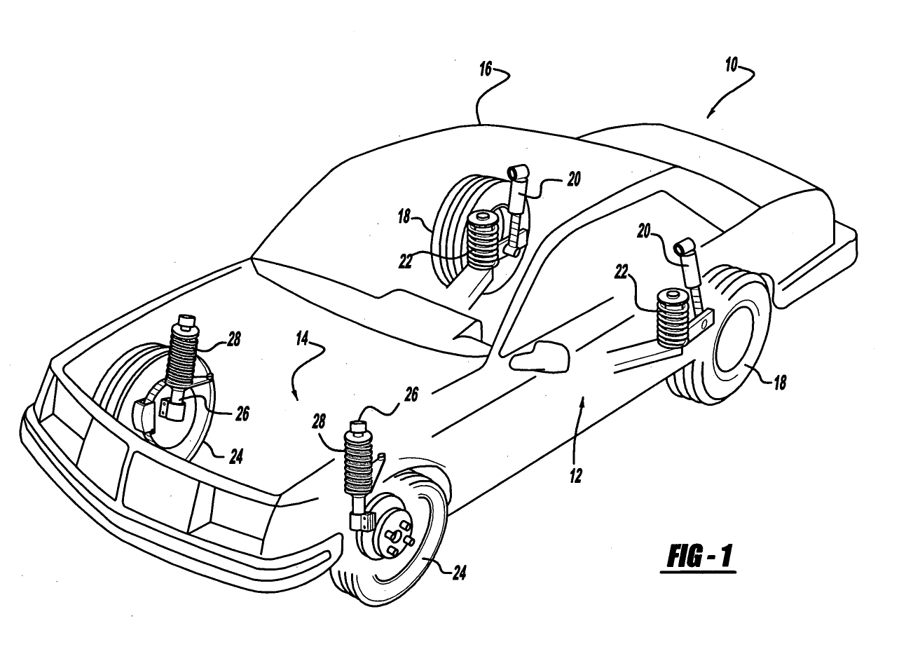

There is shown in FIG. 1 a vehicle incorporating a suspension system having the strut assembly in accordance with the present invention and which is designated generally by the reference numeral 10. Vehicle 10 comprises a rear suspension 12, a front suspension 14 and a body 16. Rear suspension 12 has a transversely extending rear axle assembly (not shown) adapted to operatively support the vehicle's rear wheels 18. The rear axle assembly is operatively connected to body 16 by means of a pair of shock absorbers 20 and a pair of helical coil springs 22. Similarly front suspension 14 includes a transversely extending front axle assembly (not shown) to operatively support the vehicle's front wheels 24. The front axle assembly is operatively connected to body 16 by means of a second pair of shock absorbers 26 and by a pair of shaped helical coil springs 28. Shock absorbers 20 and 26 serve to dampen the relative motion of the unsprung portion (i.e. front and rear suspensions 12 and 14, respectively) and the sprung portion (i.e. body 16) of vehicle 10. While vehicle 10 has been depicted as a passenger car having front and rear axle assemblies, shock absorbers 20 and 26 may be used with other types of vehicles and/or in other types of applications such as vehicles incorporating independent front and/or independent rear suspension systems. Further, the term “shock absorber” as used herein is meant to be dampers in general and thus will include McPherson struts. Also, while front suspension 14 is illustrated having a pair of McPherson struts or shock absorbers 26, it is within the scope of the present invention to have rear suspension 12 incorporate a pair of McPherson struts or shock absorbers 26 if desired.

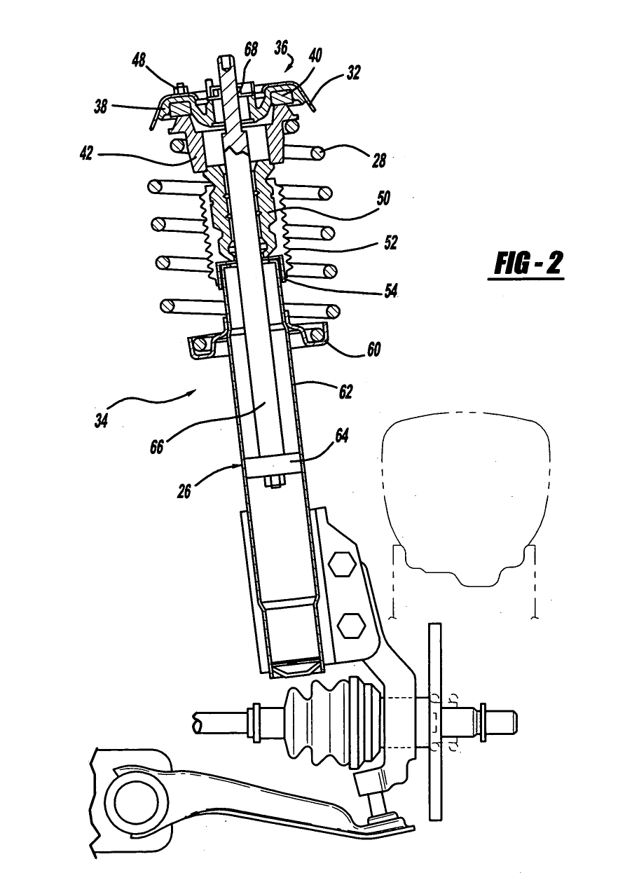

Referring now to FIG. 2, the front wheel assembly for vehicle 10 is illustrated in greater detail. Body 16 defines a shock tower 32 comprising sheet metal of vehicle 10 within which is mounted a McPherson strut assembly 34 which comprises a telescoping device in the form of shock absorber 26, coil spring 28 and a top mount assembly 36. McPherson strut assembly 34 including shock absorber 26, coil spring 28 and top mount assembly 36 are attached to vehicle 10 using shock tower 32. Top mount assembly 36 comprises a top mount 38, a bearing assembly 40 and an upper spring seat 42. Top mount 38 comprises an integral molded body and a rigid body member, typically made of stamped steel. Top mount assembly 36 is mounted to body 16 by bolts 48. Bearing assembly 40 is friction fit within molded body 44 to be seated in top mount 38 so that one side of bearing assembly 40 is fixed relative to top mount 38 and shock tower 32. The second side of bearing assembly freely rotates with respect to the first side of bearing assembly 40, top mount 38 and shock tower 32.

The free rotating side of bearing assembly 40 carries upper spring seat 42 that is clearance fit to the outer diameter of bearing assembly 40. A jounce bumper 50 is disposed between upper spring seat 42 and shock absorber 26. Jounce bumper 50 comprises an elastomeric material which is protected by a plastic dirt shield 52. A bumper cap 54 is located on shock absorber 26 to interface with jounce bumper 50 and plastic dirt shield 52.

A lower spring seat 60 is attached to shock absorber 26 and coil spring 28 is disposed between upper spring seat 42 and lower spring seat 60 to isolate body 16 from front suspension 14. Shock absorber 26 comprises a pressure tube 62, a piston assembly 64 and a telescoping rod or piston rod 66. While shock absorber 26 is illustrated as a mono-tube design, it is within the scope of the present invention to utilize a dual-tube shock absorber for shock absorber 26. Also, while shock absorber 26 is illustrated in FIG. 2, it is to be understood that shock absorber 20 may also include the features described herein for shock absorber 26.

Prior to the assembly of McPherson strut assembly 34 into vehicle 10, the pre-assembly McPherson strut assembly 34 is performed. Bumper cap 54, jounce bumper 50 and dirt shield 52 are assembled to shock absorber 26. Coil spring 28 is assembled over shock absorber 26 and positioned within lower spring seat 60. Upper spring seat 42 is assembled onto shock absorber 26 and correctly positioned with respect to coil spring 28. Bearing assembly 40 is positioned on top of upper spring seat 42 and top mount 38 is positioned on top of bearing assembly 40. This entire assembly is positioned within an assembly machine which compresses coil spring 28 such that the end of piston rod 66 extends through a bore located within top mount assembly 36. A retaining nut 68 is threadingly received on the end of piston rod 66 to secure the assembly of McPherson strut assembly 34.

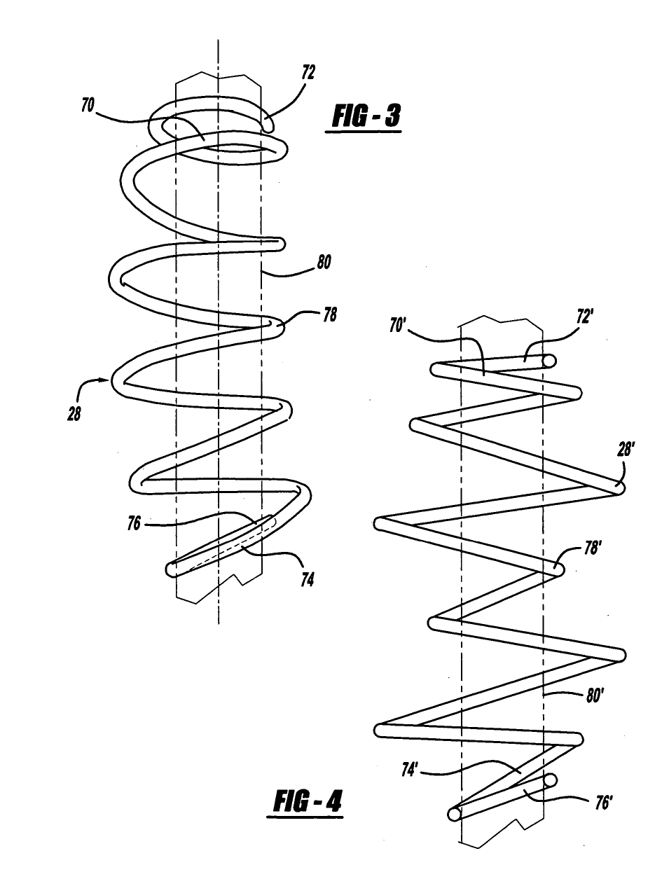

Coil spring 28 is illustrated in its free or uncompressed state in FIG. 3. Coil spring 28 comprises an upper winding 70 having an end 72, a lower winding 74 having an end 76 and a central winding 78 defining an internal cylinder disposed between upper and lower windings 70 and 74, respectively. FIG. 3 illustrates that upper winding end 70 is not parallel with lower winding end 76 and that the overall shape for coil spring 28 is a banana or arc shape. Coil spring 28 does not have to be flexed or distorted in order to allow for the assembly of shock absorber 26. This allows for the simplified loading of all components into an assembly machine before initiating the assembly. Once coil spring 28 is compressed, the end of piston rod 66 is articulated by means of a Vilking tool in order to extend through top mount assembly 36 and nut 68 is threadingly received on piston rod 66 to retain the assembly. Coil spring 28 can be formed such that a linear imaginary assembly cylinder 80 extends though lower winding 74, lower winding end 76, central winding 78, upper winding 70 and upper winding end 72. Assembly cylinder 80 to allow for the insertion of shock absorber 26 through coil spring 28 while coil spring 28 is in its uncompressed state.

Once assembled and properly orientated in vehicle 10 as shown in FIG. 2 with upper winding end 72 mating with upper spring seat 42 and lower winding end 76 mating with lower spring seat 60. The banana or arch shape of coil spring 28 will cause a lateral force to be exerted to shock absorber 26. This lateral force can be directed to oppose and thus offset any lateral force that is exerted by the flexing of front suspension 14 during the operation of vehicle 10.

FIG. 4 illustrates a coil spring 28′ which can be used in place of coil spring 28. The shape of the coil spring for front suspension is not limited to the banana or arc shape shown for coil spring 28. In order to optimize the lateral loads created by the shape of the coil spring, the coil spring can have any shape as long as assembly cylinder 80 is maintained. Coil spring 28′ comprises an upper winding 70′ having an end 72′, a lower winding 74′ having an end 76′ and a central winding 78′ disposed between upper and lower windings 70′ and 74′, respectively. FIG. 4 illustrates that upper winding end 70′ is not parallel with lower winding end 76′ and that the overall shape for coil spring 28′ is an S-shape. Coil spring 28′ does not have to be flexed or distorted in order to allow for the assembly of shock absorber 26. This allows for the loading of all components into an assembly machine before initiating the assembly. Once coil spring 28′ is compressed, the end of piston rod 66 extends through top mount assembly 36 and nut 68 is threadingly received on piston rod 66 to retain the assembly. Coil spring 28′ can be formed such that an imaginary assembly cylinder 80′ extends through lower winding 74′, lower winding end 76′, central winding 78′, upper winding 70′ and upper winding end 72′. Similar to assembly cylinder 80, assembly cylinder 80′ allows for the insertion of shock absorber 26 through coil spring 28′ while coil spring 28′ is in its uncompressed stated.

Once assembled and properly orientated in vehicle 10 similar to that shown in FIG. 2 for coil spring 28, with upper winding end 72′ mating with upper spring seat 42 and lower winding end 76′ mating with lower spring seat 60, the S-shape of coil spring 28′ will cause a lateral force to be exerted to shock absorber 26. This lateral force can be directed to oppose and thus offset any lateral force that is exerted by the flexing of front suspension 14 during the operation of vehicle 10.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A strut assembly comprising:
a telescoping device;
a first spring seat mounted to said telescoping device;
a second spring seat mounted to said telescoping device; and
a spring having a first end engaging said first spring seat and a second end engaging said second spring seat, said spring having a compressed state and an uncompressed state; wherein
said first end of said spring is not parallel with said second end of said spring when said spring is in its uncompressed state; and
said spring has a non-linear shape when said spring is in its uncompressed state.

2. The strut assembly according to claim 1, wherein said telescoping device extends through the inside of said spring when said spring is in its uncompressed state.

3. The strut assembly according to claim 1, wherein said non-linear shape is an arc.

4. The strut assembly according to claim 3, wherein said telescoping device extends through the inside of said spring when said spring is in its uncompressed state.

5. The strut assembly according to claim 1, wherein said non-linear shape is an S-shape.

6. The strut assembly according to claim 5, wherein said telescoping device extends through the inside of said spring when said spring is in its uncompressed state.

7. The strut assembly according to claim 1, wherein a linear cylinder extends through said first end of said spring through an inside of said spring and through said second end of said spring when said spring is in its uncompressed state.

8. A strut assembly comprising:
a telescoping device;
a first spring seat mounted to said telescoping device;
a second spring seat mounted to said telescoping device; and
a spring having a first end engaging said first spring seat and a second end engaging said second spring seat, said spring having a compressed state and an uncompressed state; wherein
said first end of said spring includes a first winding having a first internal diameter;
said second end of said spring includes a second winding having a second internal diameter;
said second winding is not parallel with said first winding; and
said spring has a non-linear shape when said spring is in its uncompressed state.

9. The strut assembly according to claim 8, wherein said telescoping device extends through the inside of said spring when said spring is in its uncompressed state.

10. The strut assembly according to claim 8 wherein said non-linear shape is an arc.

11. The strut assembly according to claim 10, wherein said telescoping device extends through the inside of said spring when said spring is in its uncompressed state.

12. The strut assembly according to claim 8, wherein said non-linear shape is an S-shape.

13. The strut assembly according to claim 12, wherein said telescoping device extends through the inside of said spring when said spring is in its uncompressed state.

14. the strut assembly according to claim 8, wherein:
said spring defines an internal cylinder extending between said first and second windings;
a linear cylinder extends through said first winding, through said internal cylinder and through said second winding when said spring is in its uncompressed stated.
